(19) United States
(12) Patent Application Publication
(10) Pub. No.: US 2025/0170785 A1
(43) Pub. Date: May 29, 2025

(54) MACHINE FOR THE WELDING OF PROFILED ELEMENTS MADE OF PLASTIC MATERIAL

(71) Applicant: Graf Synergy S.r.l., Nonantola (MO) (IT)

(72) Inventor: Andrea VACCARI, Nonantola (MO) (IT)

(73) Assignee: Graf Synergy S.r.l., Nonantola (MO) (IT)

(21) Appl. No.: 18/725,780

(22) PCT Filed: Dec. 15, 2022
(86) PCT No.: PCT/IB2022/062311

§ 371 Date: Jun. 30, 2024

(30) Foreign Application Priority Data
Dec. 30, 2021 (IT) 102021000033119

(51) Int. Cl. B29C 65/78; B29C 65/20; B29K 27/06; B29L 31/00

(52) U.S. Cl. CPC B29C 65/7802; B29C 65/2061; B29K 2027/06; B29L 2031/005

(57) ABSTRACT

The machine (1) comprises one welding device (3) for one first profiled element (4) and one second profiled element (5) each provided with at least one area to be welded (6), comprising:
first retaining means (8) and second retaining means (9) adapted to retain the profiled elements (4, 5) with the areas to be welded (6) facing each other;
one heating plate (17) adapted to heat the areas to be welded (6);
one movement assembly (14) for the first retaining means (8) along at least one direction of work (W) parallel to the second profiled element (5);
one movement unit (18) adapted to move the heating plate (17) along the direction of work (W);
   wherein at least one of either the movement assembly (14) or the movement unit (18) comprises one motorized actuator (21) and wherein the welding device (3) comprises one synchronization mechanism (22) adapted to move the first retaining means (8) at the same time as the heating plate (17) along the direction of work (W).

### TECHNICAL FIELD

The present invention relates to a machine for the welding of profiled elements made of plastic material.

### BACKGROUND ART

In the construction industry, machines are known for making window/door frames made of plastic material, particularly PVC.

Such window/door frames consist of a series of profiled elements made of plastic material, usually formed by extrusion or similar techniques, which are welded together in order to make a perimeter frame within which a central panel made of glass or other material can be placed, to obtain a door or window, and/or make a relevant fixed frame, applicable to a wall/partition.

The profiled elements extend along respective longitudinal directions and are each provided with an area to be welded where at least one end is located.

The area to be welded is a surface of the profiled element through which the profiled element itself is joined by welding to another profiled element.

The area to be welded is transversal to the relevant longitudinal direction and is obtained by cutting the profiled element along a direction generally inclined by an angle of 45° with respect to the longitudinal direction.

The machines of known type comprise a plurality of welding devices adapted to weld together the areas to be welded of the profiled elements.

In particular, the machines of known type have a supporting base on which the welding devices are movable depending on the size of the profiled elements and the position of the areas to be welded defined thereon.

Generally, the known welding devices comprise:
first retaining means of the first profiled element and second retaining means of the second profiled element so that the areas to be welded face each other; and
a heating plate adapted to heat the areas to be welded, movable between at least one home position, wherein it is moved away from the profiled elements, a first operating position, wherein it is positioned between the areas to be welded, and a second operating position, wherein it is in contact with the areas to be welded.

The retaining means are mutually movable to join and press the profiled elements together so as to bring the heated areas to be welded into contact with each other and carry out welding.

In this way, in fact, the partly melted areas to be welded come into intimate contact with each other and the plastic material, once cooled, hardens again keeping the profiled elements together.

In a known type of machines for the welding of profiled elements, the first retaining means are movable compared to the second retaining means, while the latter are fixed.

For this purpose, the known welding devices are, in addition, provided with a movement assembly of the first retaining means adapted to displace the first profiled element along at least one direction of work substantially parallel to the longitudinal direction of the second profiled element between at least one moving away position from the second profiled element and at least one moving close position to the second profiled element.

In the moving away position, therefore, the profiled elements are spaced apart from each other and allow for the positioning of further components of the welding device, such as precisely the heating plate, for the machining of the areas to be welded.

The known devices also comprise a movement unit of the heating plate adapted to move the latter along the direction of work between the first operating position and the second operating position.

The heating plate is, in fact, also movable with respect to the second profiled element to carry out heating of the relevant area to be welded.

Specifically, in the machines of known type, the movement assembly is motorized while the movement unit comprises elastic means adapted to keep the heating plate in the first operating position. The heating plate is moved towards the second operating position, along the direction of work, by the action of the first profiled element which, by coming into contact therewith by means of the movement assembly, pushes it towards the second profiled element. The heating plate, therefore, moves to the second operating position only at the moment when the first profiled element comes into contact therewith.

When the heating of the areas to be welded is completed, the movement assembly brings the first profiled element back to the moving away position, and at the same time, the elastic means bring the heating plate back to the first operating position.

Such a movement system is, however, extremely inaccurate and does not allow for effective heating of the profiled elements. In fact, as a result of the softening of the plastic material of the first profiled element, the heating plate tends to move back towards the first operating position due to the effect of the elastic means and to move away from the second profiled element.

During heating, it is, therefore, necessary to continuously adjust the position of the first profiled element so that the heating plate is constantly pushed into contact with the second profiled element.

Moreover, through such a movement system, the first profiled element is inevitably placed in contact with the heating plate for a longer time than the second profiled element. As a result, at the end of heating, the area to be welded of the first profiled element has a larger amount of melted plastic material than the area to be welded of the second profiled element.

As a result of joining and pressing the profiled elements together, the molten plastic material compresses and cools along a welding plane with respect to which the profiled elements are not perfectly symmetrical with each other. This drawback, in addition to jeopardizing the aesthetic effect of the window/door frame, can also result in inaccurate welding and structural defects in the window/door frame that can cause seepage and/or sealing faults between the door/window and the relevant fixed frame.

A further type of known type of machines has both the movement assembly and the movement unit provided with a motorized actuator, so that the heating plate can move independently along the direction of work. This embodiment solution, however, does not ensure synchronous movement of the first retaining means and of the heating plate and heating of the areas to be welded for the same amount of time.

A further drawback of the machines of known type is given by the fact that they must be inconveniently combined with finishing machines adapted to remove the weld bead that is formed during the melting of the profiled elements.

In fact, at the area where the profiled elements are welded, the excess portion of molten material flows out and goes to form a bead protruding from the exposed surface of the profiled elements.

For this reason, in order to give the finished window/door frame a fine aesthetic appearance, the profiled elements, once welded, must be transferred to the finishing machines to undergo a removal machining of the weld bead.

This process of removing the weld bead significantly affects the cost and timing of the window/door frame fabrication and, in addition, can be extremely complex to carry out, especially with radiused and/or curved surfaces, with the risk of causing damage and/or aesthetic defects where the welding areas are located.

In this regard, patent application WO 2013/132406 A1 partly fixes this issue and, in fact, describes a welding device provided with removal means adapted to make a groove on the peripheral edge of the area to be welded so that, following the welding of the profiled elements, the weld bead extends inwards into the profiled elements and is, therefore, not visible on the exposed surface of the window/door frame.

However, the machine described by WO 2013/132406 A1 requires that the removal means be arranged in a reference plane substantially parallel to the areas to be welded and that the retaining means both be movable to bring the areas to be welded into contact with the removal means themselves.

In this way, the removal means perform the machining simultaneously on both areas to be welded and in a symmetrical manner, so as to generate a welding area that is itself symmetrical and free of aesthetic and/or structural imperfections.

It is apparent that, in order to carry out rapid and optimal machining of the areas to be welded, a movement system similar to the movement unit of the known heating plate is hardly applicable to the removal means described by WO 2013/132406 A1.

In particular, by applying the removal means described by WO 2013/132406 A1 to the machines of known type, the welding device would not allow synchronous movement of the first retaining means and of the removal means themselves and would not ensure symmetrical machining of the areas to be welded with the risk of also compromising the structural characteristics of the window/door frame.

### DESCRIPTION OF THE INVENTION

The main aim of the present invention is to devise a machine for the welding of profiled elements made of plastic material that allows optimal and homogeneous heating of the areas to be welded of the profiled elements.

Within such a technical aim, one object of the present invention is to obtain window/door frames with a fine aesthetic effect and free of structural defects.

A further object of the present invention is to devise a machine for the welding of profiled elements made of plastic material that allows for convenient and easy movement of the relevant components and that, at the same time, has small dimensions and is structurally simple.

Another object of the present invention is to devise a machine for the welding of profiled elements made of plastic material that will eliminate the need to transfer the welded profiled elements to further machines adapted to remove the weld bead and to finish the welded areas subsequently to the removal of the weld bead. Another object of the present invention is to devise a machine for the welding of profiled elements made of plastic material that can overcome the aforementioned drawbacks of the prior art within the framework of a simple, rational, easy and effective to use as well as cost-effective solution.

The aforementioned objects are achieved by this machine for the welding of profiled elements made of plastic material having the characteristics of claim 1.

### BRIEF DESCRIPTION OF THE DRAWINGS

Other characteristics and advantages of the present invention will become more apparent from the description of a preferred, but not exclusive, embodiment of a machine for the welding of profiled elements made of plastic material, illustrated by way of an indicative, yet non-limiting example, in the attached tables of drawings in which:

FIG. 1 is an axonometric view of the machine according to the invention;

FIGS. 2 and 3 are axonometric views of the welding device according to the invention in an operational configuration, from different angles;

FIG. 4 is an axonometric detailed view of a component of the welding device according to the invention;

FIG. 5 is a view from above of the welding device according to the invention.

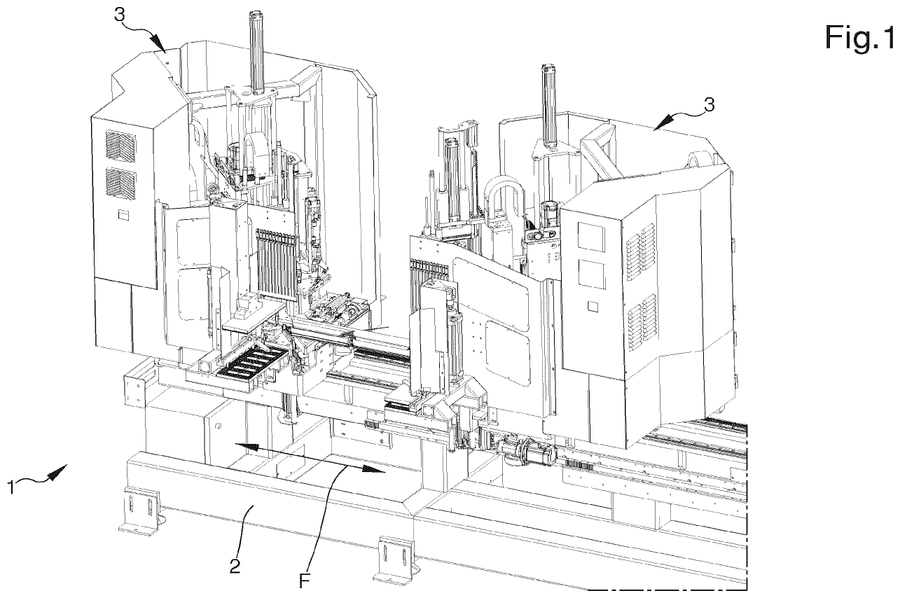

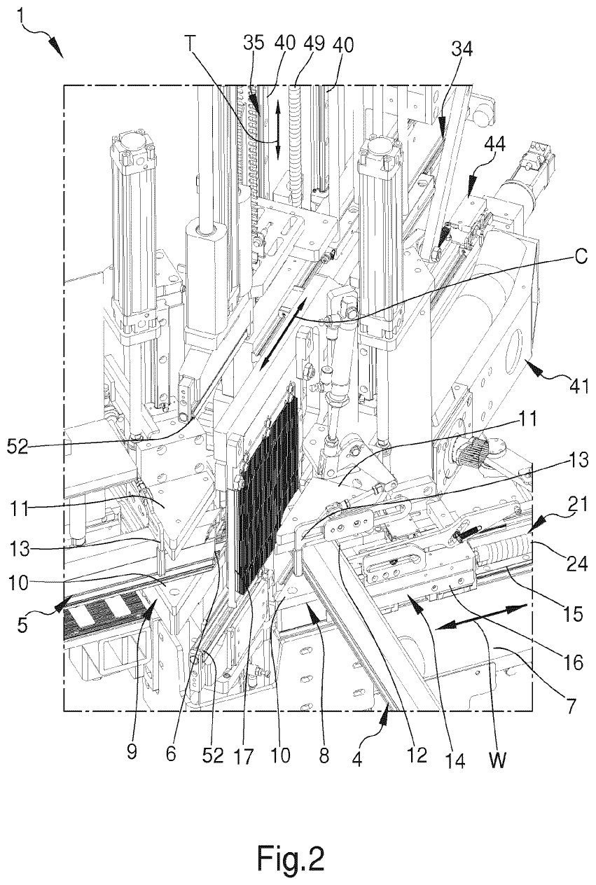

### EMBODIMENTS OF THE INVENTION

With particular reference to these figures, reference numeral 1 globally indicates a machine for the welding of profiled elements made of plastic material.

The machine 1 can be used in the welding of profiled elements made of plastic material, preferably PVC, to make a window/door frame.

It cannot, however, be ruled out that the profiled elements be made of a heat-sealable plastic material other than PVC and/or of a plastic material loaded with a reinforcing material, e.g., in the form of fibers such as glass fibers or the like. Likewise, embodiment solutions cannot be ruled out wherein the profiled elements are made partly of a plastic material and partly of a different material, in a manner similar to some materials of known type that, for example, are provided with a canopy, an outer covering, an inner core made of metal, wood, or the like.

The machine 1 for the welding of profiled elements made of plastic material comprises at least one supporting base 2 and at least one welding device 3 of at least one first profiled element 4 and of at least one second profiled element 5 extending along respective longitudinal directions, which form part of the perimeter frame of the window/door frame.

Specifically, in the embodiment shown in the figures, the machine 1 comprises two welding devices 3 adapted to weld the first profiled element 4 to the respective second profiled elements 5.

The first profiled element 4 and the second profiled element 5 each have at least one area to be welded 6 where at least one relevant end is located.

In the context of this disclosure, the expression “area to be welded” refers to a surface of the profiled element through which the profiled element itself is joined by welding to another profiled element, according to a method that will be described in more detail later in this disclosure.

Specifically, each of the profiled elements 4, 5 has at least two areas to be welded 6 defined at their respective ends.

Appropriately, the areas to be welded 6 are inclined by an angle of between 10° and 80° with respect to the longitudinal direction of the profiled element 4, 5.

Preferably, the areas to be welded 6 are inclined by an angle substantially equal to 45°.

The supporting base 2 extends along a direction of positioning F and the welding devices 3 are associated with the supporting base 2, mutually movable to arrange themselves at the ends of the first profiled element 4.

The welding device 3 comprises at least one base frame 7 associated with the supporting base 2 and retaining means 8, 9 of the profiled elements 4, 5 associated with the base frame 7 and adapted to retain the profiled elements 4, 5 with the areas to be welded 6 facing each other.

Specifically, the retaining means 8, 9 comprise first retaining means 8 of the first profiled element 4 and second retaining means 9 of the second profiled element 5.

Each of the retaining means 8, 9 comprises at least one holding plane 10 of the relevant profiled element 4, 5, substantially horizontal, and at least one clamping assembly 11 adapted to keep the profiled element 4, 5 secured to the relevant holding plane 10.

The clamping assembly 11 is of the type of a vice operated vertically by a piston cylinder, and is adapted to press the profiled element 4, 5 onto the holding plane 10.

Each of the retaining means 8, 9 also comprises at least one abutment plane 12 of the relevant profiled element 4, 5, which is substantially vertical, and a retaining assembly 13 adapted to keep the profiled element 4, 5 in contact with the relevant abutment plane 12.

The retaining assembly 13 is of the type of a movable hook to intercept the profiled element 4, 5 and pull it towards the abutment plane 12.

The retaining means 8, 9 are mutually movable to move the profiled elements 4, 5 close/away to each other.

In more detail, the first retaining means 8 are movable to displace the first profiled element 4 between the moving away position and the moving close position while the second retaining means 9 are fixed on the base frame 7.

The welding device 3 comprises at least one movement assembly 14 of the first retaining means 8 associated with the base frame 7 and adapted to displace the first profiled element 4 along at least one direction of work W between at least one moving away position from the second profiled element 5 and at least one moving close position to the second profiled element 5.

The direction of work W is substantially parallel to the longitudinal direction of the second profiled element 5.

The areas to be welded 6 of the first profiled element 4 and of the second profiled element 5 lie on a first plane of work P1 and on a second plane of work P2, respectively, which are substantially parallel to each other.

In the moving away position, the first plane of work P1 and the second plane of work P2 are arranged at a predefined distance D1 with each other, while in the moving close position, the first plane of work P1 and the second plane of work P2 substantially coincide.

The movement assembly 14 comprises:
first guiding means 15 associated with the base frame 7 and extending along the direction of work W;
a first carriage 16 associated with the first guiding means 15 in a sliding manner and supporting the first retaining means 8.

The welding device 3 also comprises at least one heating plate 17 associated with the base frame 7 and adapted to heat the areas to be welded 6.

The heating plate 17, of the type, e.g., of an electric resistance plate or a similar heating device, when placed in contact with the relevant area to be welded 6, causes at least partial melting of the plastic material of the profiled elements 4, 5, which are then joined and pressed together to bring the melted plastic material into contact by means of the movement assembly 14. Once cooled, the plastic material hardens and keeps the profiled elements together.

The heating plate 17 is movable between:
at least one home position, wherein it is moved away from the profiled elements 4, 5;
a first operating position, wherein it is positioned between the areas to be welded 6; and
a second operating position, wherein it is in contact with the areas to be welded 6.

In more detail, the heating plate 17 lies on a reference plane B substantially parallel to the planes of work P1, P2.

In the first operating position, the reference plane B is placed at a distance D2 from the second plane of work P2.

In addition, the welding device 3 comprises at least one movement unit 18 of the heating plate 17 associated with the base frame 7 and adapted to move the heating plate 17 along the direction of work W between the first operating position and the second operating position.

The heating plate 17 is, therefore, movable with respect to the second profiled element 5 to move close to the relevant area to be welded 6.

The movement unit 18 comprises:
second guiding means 19 associated with the base frame 7 and extending along the direction of work W; and
a second carriage 20 associated with the second guiding means 19 in a sliding manner and supporting at least the heating plate 17.

At least one of either the movement assembly 14 or the movement unit 18 comprises at least one motorized actuator 21.

The motorized actuator 21 is adapted to move in a very precise and accurate manner the first retaining means 8 and, consequently, the heating plate 17.

According to the invention, the welding device 3 comprises at least one synchronization mechanism 22 positioned between the movement assembly 14 and the movement unit 18 and adapted to move the first retaining means 8 at the same time as the heating plate 17 along the direction of work W.

The synchronization mechanism 22 is adapted to simultaneously move both the first retaining means 8 and the heating plate 17 so that the areas to be welded 6 come into contact with the heating plate 17 substantially at the same time. More specifically, during movement, the heating plate 17 is always kept on a plane of symmetry between the first retaining means 8 and the second retaining means 9. Similarly, when heating is completed, the contact between the areas to be welded 6 and the heating plate 17 is broken substantially at the same time.

Specifically, each stroke fraction of the first retaining means 8 along the direction of work W corresponds to a stroke fraction of the heating plate 17 along the direction of work itself.

Advantageously, the motorized actuator 21 is mounted on one of either the first carriage 16 or the second carriage 20.

In more detail, only one of either the movement assembly 14 or the movement unit 18 comprises the motorized actuator 21, while the other of either the movement assembly 14 or the movement unit 18 lacks it.

Thus, the synchronization mechanism 22 allows the first retaining means 8 and the heating plate 17 to be moved synchronously by means of a single motorized actuator 21.

This expedient allows reducing the number of components of the machine 1 and makes the welding device 3 more compact.

For this purpose, the synchronization mechanism 22 comprises at least one linking arm 23 associated with the first carriage 16 and with the second carriage 20.

The operation of the motorized actuator 21 causes the entrainment of the other of either the first carriage 16 or the second carriage 20 along the direction of work W by means of the linking arm 23.

In the embodiment shown in the figures, the movement assembly 14 comprises the motorized actuator 21 mounted on the first carriage 16.

Specifically, the motorized actuator 21 comprises:
at least one evolving screw shaft 24 associated with the first carriage 16 by means of a threaded nut 25 and extending parallel to the first guiding means 15; and
at least one electric motor 26 adapted to set the evolving screw shaft 24 in rotation.

The rotation of the evolving screw shaft 24 causes the shift of the threaded nut 25 with respect thereto and, consequently, the sliding of the first carriage 16 along the direction of work W.

It cannot, however, be ruled out that it is the movement unit 18 that comprises the motorized actuator 21, mounted on the second carriage 20.

Embodiments cannot also be ruled out wherein both the movement assembly 14 and the movement unit 18 comprise a relevant motorized actuator 21 and wherein synchronization is done by different means, such as e.g., by an electronic link between the electric motors or by means of software.

Usefully, the linking arm 23 is associated rotatable with the base frame 7 around a substantially vertical hinge axis A.

The linking arm 23 is, therefore, constrained to the base frame 7 and is rotatable around the hinge axis A during the movement of the first retaining means 8.

Specifically, the linking arm 23 comprises at least one hinge point 27 to the base frame 7.

The hinge point 27 is defined at one end of the linking arm 23.

The linking arm 23 also comprises at least one first linking point 28 to the first carriage 16. The first linking point 28 is defined at the opposite end of the linking arm 23.

In addition, the linking arm 23 comprises at least one second linking point 29 to the second carriage 20. The second linking point 29 is positioned between the hinge point 27 and the first linking point 28.

In more detail, the linking arm 23 extends along a direction of development S and the points 27, 28, 29 are arranged aligned with each other along the direction of development S.

Advantageously, the points 27, 28, 29 are arranged with each other so that the ratio of:
the distance between the first linking point 28 and the hinge point 27, indicated on the drawings as reference D3; and
the distance between the second linking point 29 and the hinge point 27, shown on the drawings as reference D4;
   is substantially corresponding to the ratio of:
the distance between the planes of work P1, P2, indicated on the drawings as reference D1; and
the distance between the reference plane B and the second plane of work P2, shown in the drawings as reference D2.

This arrangement of points 27, 28, 29 substantially causes the first retaining means 8 and the heating plate 17 to be moved at respective speeds, which are inversely proportional to their respective distances from the second retaining means 9, that is, from the area to be welded 6 of the second profiled element 5. The heating plate 17 therefore moves at a lower speed than the first retaining means 8.

In this way, the areas to be welded 6 come into contact with the heating plate 17 substantially simultaneously and, at the same time, they move away therefrom substantially simultaneously. The areas to be welded 6 are, therefore, heated for the same amount of time so as to generate the same amount of molten plastic material. The molten plastic material, as a result of the joining and pressing of the profiled elements 4, 5, compresses and cools along a welding plane with respect to which the profiled elements 4, 5 are arranged symmetrically to each other.

In the embodiment shown in the figures, the distance D1 between the planes of work P1, P2 is substantially double the distance D2 between the reference plane B and the second plane of work P2. Similarly, the distance D3 between the first linking point 28 and the hinge point 27 is substantially double the distance D4 between the second linking point 29 and the hinge point 27.

In accordance with this embodiment, therefore, the heating plate 17 is moved at a speed substantially equal to half the speed of the first retaining means 8 so as to contact the second profiled element 5 at the time when the first profiled element 4 contacts the heating plate itself.

Usefully, the linking arm 23 comprises a first pivot 30 associated with the first linking point 28 and the first carriage 16 comprises a first guide 31 supporting the first pivot 30 in a sliding manner and extending transversely to the direction of work W.

Specifically, the first guide 31 extends orthogonally to the direction of work W. In more detail, during the rotation of the linking arm 23 around the hinge axis A, the first linking point 28 performs a curvilinear trajectory provided with a first rectilinear component substantially parallel to the direction of work W and responsible for the movement of the first carriage 16 along that direction and with a second rectilinear component substantially perpendicular to the first rectilinear component. The first guide 31, therefore, supports the sliding of the first pivot 30 along the second rectilinear component.

Advantageously, the first pivot 30 is associated rotatable with the linking arm 23 around a relevant axis of rotation R1 substantially parallel to the hinge axis A.

In more detail, the first pivot 30 is rotatable due to friction with the first guide 31. This expedient allows facilitating the sliding of the first pivot 30 along the first guide 31 and makes the movement of the linking arm 23 extremely easy.

Usefully, the linking arm 23 comprises a second pivot 32 associated with the second linking point 29 and the second carriage 20 comprises a second guide 33 supporting the second pivot 32 in a sliding manner and extending transversely to the direction of work W.

Specifically, the second guide 33 extends orthogonally to the direction of work W.

In more detail, during the rotation of the linking arm 23 around the hinge axis A, the second linking point 29 in turn performs a relevant circular trajectory provided with a relevant first rectilinear component substantially parallel to the direction of work W and responsible for the movement of the second carriage 20 along that direction and a relevant second rectilinear component substantially perpendicular to the first rectilinear component. The second guide 33, therefore, supports the sliding of the second pivot 32 along the second rectilinear component.

Advantageously, the second pivot 32 is associated rotatable with the linking arm 23 around a relevant axis of rotation R2 substantially parallel to the hinge axis A. In more detail, the second pivot 32 is rotatable due to friction with the second guide 33. This expedient allows facilitating the sliding of the second pivot 32 along the second guide 33 and promoting the movement of the linking arm 23.

Usefully, the welding device 3 also comprises displacement means 34, 35 of the heating plate 17 between the home position and the first operating position.

The displacement means 34, 35 comprise at least one unit of forward movement 34 adapted to move the heating plate 17 along a substantially horizontal operating direction C between the home position and the first operating position.

In more detail, in the home position, the heating plate 17 is set in a rearward position from the profiled elements 4, 5 in order not to clutter the work area and to allow further machining operations to be carried out.

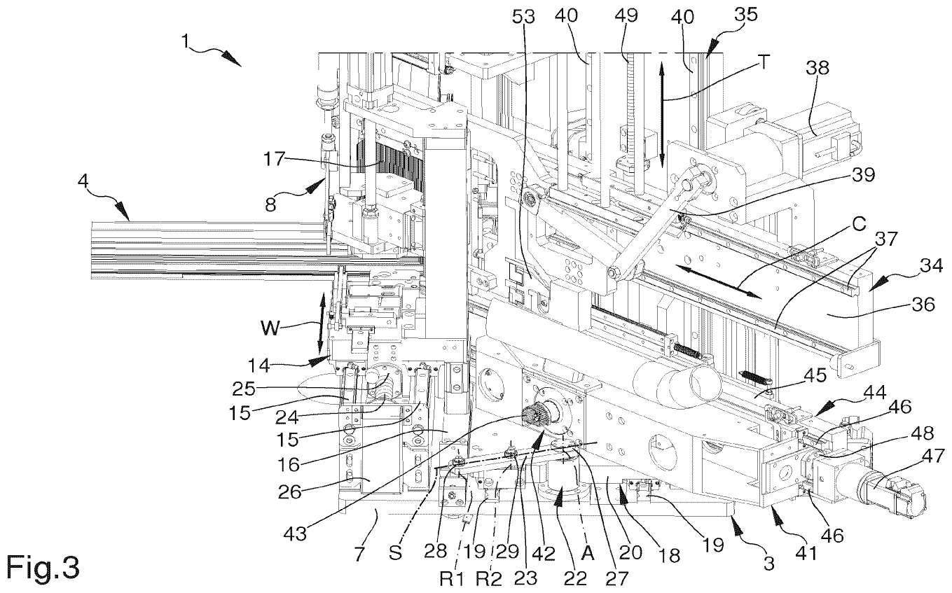

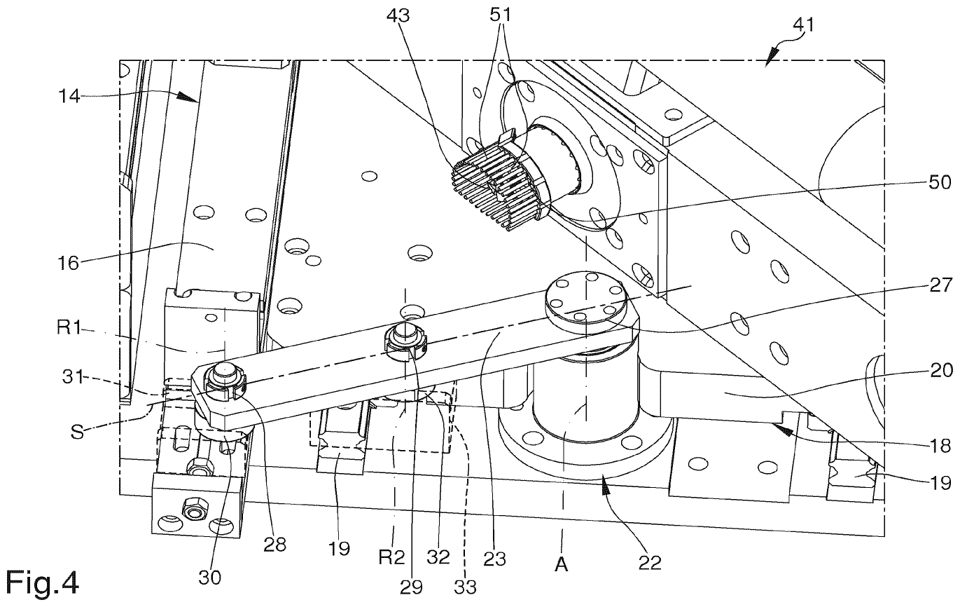

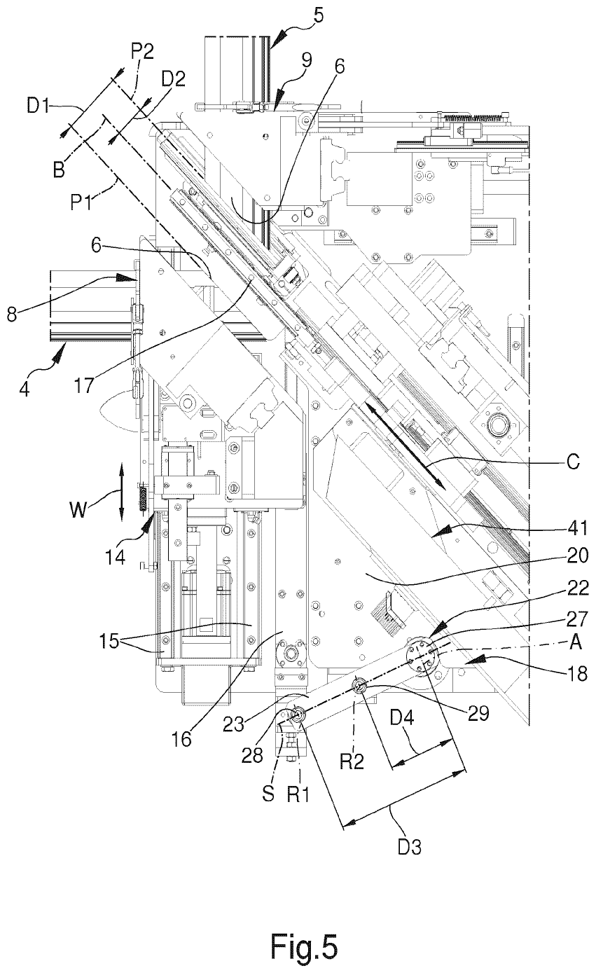

As shown in FIG. 3, the unit of forward movement 34 comprises:
at least one supporting frame 36 of the heating plate 17;
at least one guiding assembly 37 associated with the supporting frame 36, extending along the operating direction C and supporting the heating plate 17 by sliding; and
at least one actuator assembly 38, 39 associated with the supporting frame 36 and adapted to move the heating plate 17 along the operating direction C.

The operating direction C is substantially horizontal.

The actuator assembly 38, 39 is of the type of a controlled axis movement system and allows micrometric movement of the heating plate 17.

In the embodiment shown in the figures, the actuator assembly 38, 39 comprises a motor device 38 associated with the supporting frame 36 and an articulated arm 39 positioned between the motor device 38 and the heating plate 17.

The motor device 38 is of the type of an electric motor and is adapted to set the articulated arm 39 in rotation, the movement of which causes the heating plate 17 to slide along the operating direction C.

It cannot, however, be ruled out that the actuator assembly 38, 39 be of a different type.

The displacement means 34, 35 also comprise at least one sliding assembly 35 adapted to move the heating plate 17 along a substantially vertical direction of transfer T.

The function of the sliding assembly 35 is substantially to move the heating plate 17 further away when not needed.

The sliding assembly 35 comprises:
at least one guiding unit 40 associated with the second carriage 20, extending along the direction of transfer T and supporting the supporting frame 36 by sliding; and
at least one actuating unit associated with the supporting frame 36 and adapted to move the heating plate 17 along the direction of transfer T.

In a preferred embodiment, the actuating unit, not shown in detail in the figures, is of the type of a fluid-operated cylinder positioned between the second carriage 20 and the supporting frame 36.

Usefully, the welding device 3 also comprises removal means 41 adapted to remove part of the plastic material from the areas to be welded 6.

More specifically, the removal means 41 are adapted to make at least one groove on a peripheral edge of the areas to be welded 6.

In particular, the removal means 41 are adapted to make a groove at least where the exposed faces of the profiled elements 4, 5 are located.

In the context of this disclosure, the expression “exposed faces” means the surfaces of the profiled elements that are substantially flat, intended to lie substantially parallel to the lying plane of the window/door frame fabricated with the profiled elements themselves and to remain exposed once the window/door frame has been assembled. In practice, when the window/door frame is assembled on a wall or partition, the exposed faces are the surfaces of the profiled elements facing either the inner side or the outer side of the wall or partition.

More specifically, the removal means 41 are adapted to make a groove also where the side faces of the profiled elements 4, 5 are located.

In the context of this disclosure, the expression “side faces” refers to the surfaces of the profiled elements intended to lie substantially perpendicular to the lying plane of the window/door frame fabricated with the profiled elements themselves. In the case of doors or windows, the inner side faces of the profiled elements are substantially intended to intercept a central panel (e.g., a pane of glass) of the window/door frame and the outer side faces are intended to define the outer side perimeter of the window/door frame that stops against a frame of the window/door frame attached to the wall or partition. In the case, on the other hand, of the frame of the window/door frame, the inner side faces of the profiled elements are intended to stop against the door or window sash (when closed) while the outer perimeter faces are intended to face the wall or partition to which the frame is attached.

The groove ensures that, following the welding of the profiled elements, the weld bead extends towards the inside of the profiled elements 4, 5 and, therefore, is not visible from the outside.

For the purpose of this disclosure, the expression “weld bead” refers to the portion of excess molten plastic material that is compressed during the joining of the profiled elements and that may protrude from the faces of the profiled elements themselves. The weld bead, therefore, affects the entire peripheral edge of the areas to be welded 6.

Thanks to the groove, once the profiled elements 4, 5 are welded together, the relevant exposed faces and side faces are perfectly juxtaposed to each other.

The removal means 41 have, in addition, the function of removing part of the material of which the profiled elements 4, 5 are made, where the faces and/or the inner portions are located, in order to allow optimal welding.

For example, the removal means 41 are further adapted to remove a thin layer of plastic material sufficient to level and even out the areas to be welded 6.

In other words, the removal means 41 are not just for shaping grooves but can be absolutely essential for evening out and correcting any cutting errors.

Without such leveling, the areas to be welded 6 would be too irregular and, therefore, cannot be welded.

It is also emphasized that the grooves and leveling of the areas to be welded 6 are made by the removal means 41 when the profiled elements 4, 5 are already mounted on the retaining means 8, 9; the areas to be welded 6 are coupled and melted together without disassembling the profiled elements 4, 5 from the retaining means 8, 9.

In other words, the tooling of the profiled elements 4, 5 on the retaining means 8, 9 occurs only once and the welding device 3 is able to perform all the steps involved in machining without the profiled elements 4, 5 having to be set up and/or machined on other machines.

This peculiar feature, in addition to ensuring remarkable speed of execution, makes it possible to avoid welding errors due to incorrect assembly of the profiled elements 4, 5 on the retaining means 8, 9.

In fact, if grooving and/or leveling were carried out on a different machine and the profiled elements 4, 5 mounted on the welding device 3 at a later time to be welded, there would be a risk of positioning the areas to be welded 6 not perfectly facing and parallel and jeopardizing the welding of the profiled elements themselves.

Alternative embodiments of the present invention cannot however be ruled out wherein the machine 1 is not provided with the removal means 41 and the groove making and/or leveling of the profiled elements 4, 5 are carried out on separate milling machines before the profiled elements themselves are placed on the machine 1.

The removal means 41 are provided with a tool assembly 42 supporting a pair of work tools 43 movable in rotation around a relevant axis of rotation.

In more detail, the tool assembly 42 comprises at least one electric motor and a motor shaft associated with the motor itself, at the ends of which the work tools 43 are arranged.

The electric motor is adapted to place the work tools 43 in rotation around the relevant axis of rotation.

The tool assembly 42 is positionable between at least one rearward position, wherein it is moved away from the profiled elements 4, 5, a first position of work, wherein it is positioned between the areas to be welded 6 and wherein the work tools 43 face the respective areas to be welded 6, and a second position of work, wherein the work tools 43 are in contact with the areas to be welded 6 in order to remove the plastic material.

Specifically, in the first position of work, the tool assembly 42 lies on the reference plane B.

In this position, the work tools 43 are arranged facing the relevant areas to be welded 6, so that the plastic material can be removed simultaneously on both the profiled elements 4, 5.

The work tools 43 are arranged on opposite sides of the tool assembly 42 with respect to the reference plane B.

In more detail, the axes of rotation are substantially parallel to each other and perpendicular to the reference plane B.

The axes of rotation are, therefore, perpendicular to the relevant areas to be welded 6 and inclined by 45° with respect to the longitudinal direction of the relevant profiled element 4, 5.

Between the first position of work and the second position of work, the tool assembly 42 is movable in turn along the direction of work W.

Similarly to the heating plate 17, in fact, the tool assembly 42 is also movable close to the second profiled element 5 to carry out machining.

Advantageously, the removal means 41 are also mounted on the second carriage 20.

It follows that, similarly to the heating plate 17, the removal means 41 are also movable synchronously together with the first retaining means 8 and at respective speeds which are inversely proportional to their respective distances from the second retaining means 9. The synchronization mechanism 22 is, therefore, further adapted to also move the tool assembly 42 so that the work tools 43 come into contact with the areas to be welded 6 substantially at the same time. In this way, the machine 1 according to the invention allows an extremely precise and accurate removal of the plastic material from both areas to be welded 6 at the same time.

Between the rearward position and the first position of work, on the other hand, the tool assembly 42 is movable along the operating direction C.

Usefully, the removal means 41 also comprise a positioning system 44 of the tool assembly 42 between the rearward position, the first position of work and the second position of work.

The positioning system 44 is adapted to arrange the work tools 43 where the areas to be welded 6 are located and to move them over the same to remove the plastic material.

The positioning system 44 comprises at least one holding frame 45 of the tool assembly 42.

The positioning system 44 then comprises at least one pair of guides 46 associated with the holding frame 45, extending parallel to the operating direction C and supporting the tool assembly 42 by sliding.

In addition, the positioning system 44 comprises a driving assembly adapted to move the tool assembly 42 along the operating direction C.

The driving assembly comprises a first actuator 47 and a first threaded shaft that extends parallel to the operating direction C.

The first threaded shaft meshes a first threaded wheel 48 associated with the removal means 41.

The rotation of the first threaded shaft causes the movement of the tool assembly 42 along the operating direction C.

Usefully, the removal means 41 are in turn movable along the direction of transfer T.

For this purpose, the holding frame 45 is associated with the guiding unit 40 in a sliding manner.

The positioning system 44 comprises a second driving assembly adapted to move the removal means 41 along the direction of transfer T.

The second driving assembly comprises a second actuator and a second threaded shaft 49 that extends parallel to the direction of transfer T.

The second threaded shaft 49 meshes a second threaded wheel associated with the holding frame 45.

The rotation of the second threaded shaft 49 causes the movement of the holding frame 45 and, consequently, of the tool assembly 42 along the direction of transfer T.

The positioning system 44, therefore, allows the work tools 43 to be positioned extremely precisely to carry out the removal of the plastic material.

In addition, it is worth noting that the special expedient of mounting the heating plate 17 and the tool assembly 42 on the same guiding unit 40 allows keeping the overall dimensions of the welding device 3 considerably small and limiting the components thereof.

The removal means 41 also comprise a suction unit adapted to suck up the residues of plastic material generated during the removal of the plastic material itself.

The suction unit is associated with the tool assembly 42 and comprises a suction port 50 defined at the work tool 43 through which the residues of plastic material are conveyed towards a recovery container.

For this purpose, moreover, the work tool 43 is of helical conformation so as to convey the removed chips towards the suction port 50 and to facilitate the removal thereof. It cannot, however, be ruled out that the work tool 43 is of a different conformation.

In more detail, the work tool 43 is arranged through the suction port 50 towards the areas to be welded 6.

In addition, the suction unit comprises a series of brush elements 51 arranged around the suction port 50 in a radial pattern.

During removal, the brush elements 51 contact the areas to be welded 6 and allow the effective removal of the residues made of plastic material therefrom, thus promoting the suction thereof.

Advantageously, the welding device 3 comprises containment means 52, 53 adapted to abut on at least the exposed faces at the areas to be welded 6 to contain the weld bead.

In more detail, the containment means 52, 53 are adapted to contain the weld bead protruding from the exposed faces and from the outer side faces of the profiled elements 4, 5.

To this end, the containment means 52, 53 comprise:
a pair of containment bodies 52 adapted to contain the weld bead protruding from the exposed faces of the profiled elements 4, 5; and
at least one containment element 53 adapted to contain the weld bead protruding from the outer side faces.

Specifically, the containment bodies 52 are arranged facing each other from opposite sides (above and below) from the lying plane of the profiled elements 4, 5 and are movable in mutual approach to abut on the relevant exposed faces of the profiled elements themselves at the areas to be welded 6.

The containment element 53, on the other hand, is adapted to abut on the outer side faces of the profiled elements 4, 5 at the areas to be welded 6.

Specifically, the containment element 53 is V-shaped and is intended to contact the outer side faces of the profiled elements 4, 5 when joined together.

The containment means 52, 53 are known to the field technician and will not be described in detail in this disclosure.

Advantageously, the containment means 52, 53 are in turn mounted on the second carriage 20.

The containment means 52, 53 are, therefore, also movable along the direction of work W following the movement of the first retaining means 8.

Following the heating of the areas to be welded 6, in fact, the heating plate 17 is brought to the home position and the first retaining means 8 are moved to the moving close position to join and press the profiled elements 4, 5 together.

Specifically, once the areas to be welded 6 are juxtaposed, the first retaining means 8 are further moved along the direction of work W to press the profiled elements 4, 5 together. During this step, the molten plastic material compresses and the areas to be welded 6 move closer and closer together. In particular, the area to be welded 6 of the first profiled element 4 moves towards the area to be welded 6 of the second profiled element 5.

In more detail, in use, the containment means 52, 53 are arranged in the reference plane B.

The special expedient of providing for the containment means 52, 53 to be mounted on the second carriage 20 and arranged in the reference plane B, causes the containment bodies 52 and the containment element 53 to move at the same time as the first retaining means 8 during the joining and pressing of the first profiled element 4 to the second profiled element 5 so as to ensure optimum containing of the weld bead until the joining and pressing operations are completed and to achieve a fine aesthetic effect of the resulting welding area.

It has in practice been ascertained that the described invention achieves the intended objects, and in particular, the fact is emphasized that, thanks to the synchronization mechanism, the machine for the welding of profiled elements made of plastic material according to the invention enables optimal and homogeneous heating of the areas to be welded of the profiled elements.

Thus, the synchronization mechanism makes it possible to obtain window/door frames with a fine aesthetic effect and free of structural defects.

In addition, this machine allows for convenient and easy movement of the relevant components while, at the same time, having small dimensions and being structurally simple.

Finally, thanks to the removal means and to the containment means, the machine according to the invention eliminates the need to transfer the welded profiled elements to further machines adapted to remove the weld bead and to finish the welded areas subsequently to the removal of the weld bead itself.

1. Machine for the welding of profiled elements made of plastic material, comprising:
at least one supporting base;
at least one welding device for at least one first profiled element and at least one second profiled element made of plastic material, which extend along respective longitudinal directions and each provided, at at least one of its ends, with at least one area to be welded substantially inclined by an angle of between 10° and 80° with respect to said respective longitudinal direction, said welding device comprising:
at least one base frame associated with said supporting base;
first retaining means for the first profiled element and second retaining means for the second profiled element associated with said base frame and adapted to retain said profiled elements with said areas to be welded facing each other;
at least one heating plate associated with said base frame and adapted to heat said areas to be welded, movable between at least one home position, wherein it is moved away from said profiled elements, a first operating position, wherein it is positioned between said areas to be welded, and a second operating position, wherein it is in contact with said areas to be welded;
at least one movement assembly for said first retaining means associated with said base frame and adapted to displace said first profiled element along at least one direction of work (W) substantially parallel to the longitudinal direction of said second profiled element between at least one moving away position from said second profiled element and at least one moving close position to said second profiled element;
at least one movement unit associated with said base frame and adapted to move said heating plate along said direction of work (W) between said first operating position and said second operating position;
wherein at least one of either said movement assembly or said movement unit comprises at least one motorized actuator;
wherein said welding device comprises at least one synchronization mechanism positioned between said movement assembly and said movement unit and adapted to move said first retaining means (8) at the same time as said heating plate along said direction of work (W).

2. Machine according to claim 1, wherein said movement assembly comprises:
first guiding means associated with said base frame and extending along said direction of work (W);
a first carriage associated with said first guiding means in a sliding manner and supporting said first retaining means.

3. Machine according to claim 1 wherein said movement unit comprises:
second guiding means associated with said base frame and extending along said direction of work (W);
a second carriage associated with said second guiding means in a sliding manner and supporting at least said heating plate.

4. Machine according to claim 1, wherein said motorized actuator is mounted on one of either said first carriage or said second carriage, and by the fact that said synchronization mechanism comprises at least one linking arm associated with said first carriage and with said second carriage, the actuation of said motorized actuator causing the entrainment of the other of either said first carriage or said second carriage along said direction of work (W) by means of said linking arm.

5. Machine according to claim 1, wherein that said linking arm is associated rotatable with said base frame around a substantially vertical hinge axis (A).

6. Machine according to claim 1, wherein that said linking arm comprises:
at least one hinge point to said base frame;
at least one first linking point to said first carriage; and
at least one second linking point to said second carriage;
wherein said second linking point is positioned between said hinge point and said first linking point.

7. Machine according to claim 1, wherein said linking arm extends along a direction of development(S), said points being arranged aligned with each other along said direction of development(S).

8. Machine according to claim 1, wherein said areas to be welded of said first profiled element and said second profiled element lie on a first plane of work (P1) and on a second plane of work (P2) respectively, substantially parallel to each other, and said heating plate lies on a reference plane (B) substantially parallel to said planes of work (P1, P2), wherein the ratio of the distance (D3) between said first linking point and said hinge point and the distance (D4) between said second linking point and said hinge point is substantially corresponding to the ratio of the distance (D1) between said planes of work (P1, P2) and the distance (D2) between said reference plane (B) and said second plane of work (P2).

9. Machine according to claim 1, wherein said synchronization mechanism comprises a first pivot associated with said first linking point and by the fact that said first carriage comprises a first guide supporting said first pivot in a sliding manner and extending transversely to said direction of work (W).

10. Machine according to claim 1, wherein said synchronization mechanism comprises a second pivot associated with said second linking point and by the fact that said second carriage comprises a second guide supporting said second pivot in a sliding manner and extending transversely to said direction of work (W).

11. Machine according to claim 1, wherein, at least one of either said first pivot or said second pivot is associated rotatable with said linking arm around a relevant axis of rotation (R1, R2) substantially parallel to said hinge axis (A).

12. Machine according to claim 1, wherein said welding device comprises removal means adapted to remove part of the plastic material from said areas to be welded and provided with a tool assembly supporting a pair of work tools movable in rotation around a relevant axis of rotation, positionable among at least one rearward position, wherein it is moved away from said profiled elements, a first position of work, wherein it is positioned between said areas to be welded and wherein said work tools face the respective areas to be welded, and a second position of work, wherein said work tools are in contact with said areas to be welded in order to remove said plastic material.

13. Machine according to claim 1, wherein between said first position of work and said second position of work, said tool assembly is movable along said direction of work (W) and by the fact that said removal means are mounted on said second carriage.

14. Machine according to claim 1, wherein in said first position of work, said tool assembly lies on said reference plane (B).
